(19) United States
(12) Patent Application Publication
(10) Pub. No.: US 2016/0168005 A1
(43) Pub. Date: Jun. 16, 2016

(54) METHOD FOR PRODUCING A LARGE QUARTZ-GLASS TUBE

(71) Applicant: HERAEUS QUARZGLAS GMBH & CO. KG, Hanau (DE)

(72) Inventors: Boris GROMANN, Aschaffenburg (DE); Burtchard OBERLE, Elsenfeid (DE); Christian SCHENK, Ingelheim (DE); Gero FISCHER, Kleinwallstadt (DE); Pèlagie DECLERCK, Gelnhausen (DE); Bemhard FRANZ, Giessen-Lützellinden (DE); Ulrich LEIN, Rodenbach (DE); Alexander LAAZ, Erlansee (DE); Achim HOFMANN, Frankfurt (DE)

(73) Assignee: Heraeus Quarzglas GmbH & Co., KG, Hanau (DE)

(21) Appl. No.: 14/904,308

(22) PCT Filed: Jul. 8, 2014
(86) PCT No.: PCT/EP2014/064541

§ 371 Date: Jan. 11, 2016

(30) Foreign Application Priority Data
Jul. 12, 2013 (DE) 102013107435.9

(51) Int. Cl. C03B 23/053; C03B 23/08; C03B 23/043; C03B 23/07

(52) U.S. Cl. CPC C03B 23/053; C03B 23/07; C03B 23/08; C03B 23/043

(57) ABSTRACT

A method for producing a large quartz-glass pipe is provided. In a first forming step, an intermediate cylinder made of quartz glass and having an intermediate-cylinder wall thickness and outside diameter is formed by using a forming tool and is then cooled. In a second shaping step, at least one length segment of the cooled intermediate cylinder is fed to a heating zone, heated to a softening temperature zone by zone therein, and, while rotating about the longitudinal axis of the intermediate cylinder, shaped into the large quartz-glass pipe having a final wall thickness and outside diameter. The quartz glass is synthetically produced and has an average hydroxyl group content of 10 ppm by weight or less. If the intermediate cylinder is divided into length segments of 1 cm, adjacent length segments have a difference of less than 2 ppm by weight in the average hydroxyl group content thereof.

### CROSS-REFERENCE TO RELATED APPLICATIONS

This application is a Section 371 of International Application No. PCT/EP2014/064541, filed Jul. 8, 2014, which was published in the German language on Jan. 15, 2015, under International Publication No. WO 2015/004103 and the disclosure of which is incorporated herein by reference.

### BACKGROUND OF THE INVENTION

The present invention refers to method for producing a large quartz-glass tube by multi-stage forming, wherein in a first forming step using a forming tool, an intermediate cylinder of quartz glass is formed with an intermediate-cylinder wall thickness and an intermediate-cylinder outer diameter and is subsequently cooled, and in that in a second shaping step, at least one length segment of the cooled intermediate cylinder is supplied to a heating zone, heated therein zone by zone to a softening temperature and is shaped while rotating about its longitudinal axis into the large quartz-glass tube with a final wall thickness and a final outer diameter.

By forming a hollow cylinder of quartz glass in two or more shaping stages, the outer diameter of the tube is enlarged or its cross-sectional profile is changed. Shaping in several stages makes it easier to observe the given radial dimensions, such as outer diameter, inner diameter or wall thickness of the drawn-off tube strand.

A generic two-stage shaping method is known from DE 10 2007 061 609 A1. In a first shaping step, also called “compression,” a start cylinder of quartz glass which is rotating about its longitudinal axis is softened area by area in a front heating zone generated by electrical heating, and is compressed in this process via a mandrel fixed in the longitudinal axis of the cylinder, and is simultaneously pressed with its cylinder outer jacket against a forming part arranged at a predetermined distance from the mandrel. A hollow, cylindrical intermediate product of softened quartz glass is thereby produced with an inner diameter defined by the mandrel and an outer diameter defined by the forming part. The gap between the mandrel and the forming part defines the nominal wall thickness of the hollow intermediate product.

As soon as the intermediate product has reached a certain dimensional stability, it is subjected in the same work process to the second shaping step, which is called “blowing up” or “inflating.” In this process, the hollow intermediate product is continuously supplied to a rear heating zone, which is also produced by electrical heating, and it is softened therein and blown up or inflated by applying an internal pressure in the cavity against a second forming part. From there, a thin-walled quartz glass tube is drawn off with an outer diameter of 305 mm in the direction of the longitudinal axis of the tube. The “drawing-off” operation may here be limited to an axial stabilization of the quartz glass tube, without a tensile force, which is further elongating the quartz glass tube, being applied to the quartz glass tube.

The outer diameter of the quartz glass tube is defined by the radial distance of the forming tool from the longitudinal axis (e.g., which is equal to the drawing axis), and the wall thickness by the ratio of the feed speed of the start cylinder and the withdrawal speed of the quartz glass tube.

Since compressing and blowing are carried out in one operation, much time and energy are saved. The inner wall of the quartz glass tube obtained thereby is formed without any tool. The outer jacket, however, gets into contact with the forming tool, so that drawing streaks or other defects may form at a high pressure applied to the soft quartz glass. Moreover, diameter changes may occur after detachment of the quartz-glass tube strand from the last forming tool. Since increasing demands are made on the absence of defects and the dimensional stability of the components, this procedure turns out to be inadequate.

These drawbacks are avoided by a discontinuous two-stage shaping method, as is known from JP H04-26522 A. To produce a quartz glass tube from synthetic quartz glass, a quartz glass block is shaped in a first shaping stage into a thick-walled hollow cylinder. The hollow cylinder is blown up in a second shaping stage into a thin-walled quartz glass tube. The thick-walled hollow cylinder is clamped in a horizontal orientation in a glass lathe and softened zone by zone by means of a small induction-heated graphite heating element which is continuously moved along the longitudinal axis of the hollow cylinder. The softened region is elongated and simultaneously blown up or inflated by applying a gas internal overpressure, without any contact with a forming tool into a thin-walled quartz glass tube of a large outer diameter.

It is true that the contact-free blowing up of the hollow cylinder in the last shaping step avoids drawing streaks and similar defects, as occur in the use of forming tools. On the other hand, compliance with a given dimensional stability of the drawn-off quartz glass tube turns out to be problematic in this procedure.

A solution to this problem is offered by a method variant known from JP 2004-149325 A, in which the last shaping stage is repeated several times, so that the final diameter of the quartz glass tube is obtained by way of gradual enlargement. The diameter here is enlarged by rotating the start tube, which is softened zone by zone, under the action of the centrifugal force.

This results in a comparatively low degree of deformation in each individual enlargement step, which is accompanied by a smaller deviation from the nominal dimension in the respectively obtained intermediate size. Moreover, each enlargement step offers the possibility of considering and correcting dimensional deviations existing in the respective initial tube. On the other hand, it is evident that this procedure requires great efforts in terms of time and energy that, however, are only justifiable in the case of large quartz-glass tubes and when very high demands are made on the dimensional stability.

Geometrical fluctuations are exponentially increasing with the outer diameter of the end tube. The greater the end tube diameter, the more difficult gets the production of a dimensionally stable large tube.

### BRIEF SUMMARY OF THE INVENTION

It is therefore an objective of the present invention to provide a method which, at an economically justifiable expense, permits the production of quartz glass tubes that, even at a large outer diameter of more than 500 mm, show a great dimensional stability.

This objective, starting from a method of the aforementioned type, is achieved according to the present invention in that the quartz glass is synthetically produced and has a mean hydroxyl group content of 10 wt. ppm or less, with the additional proviso that when the intermediate cylinder is subdivided into length segments having a length of 1 cm, neighboring length segments show a difference of less than 2 wt. ppm in their mean hydroxyl group content.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows a side view of an apparatus for carrying out a first shaping process for the purpose of producing an intermediate tube of synthetically produced quartz glass; and

FIG. 2 shows a side view of an apparatus for carrying out a second shaping process for the purpose of producing a large tube from the intermediate tube.

### DETAILED DESCRIPTION OF THE INVENTION

In the method according to the present invention, a forming tool is used in the first forming step, resulting in an intermediate cylinder with a defined outer diameter. The forming tool is, for instance, composed of forming jaws, as have been described above, or is a drawing nozzle, as is used when quartz glass tubes are pulled from a crucible. In the last-mentioned case, a viscous quartz glass mass is shaped by means of the drawing nozzle into a quartz glass strand. The second shaping step poses the problem of achieving an economically acceptable degree of shaping (i.e., enlargement of the outer diameter of the intermediate layer), while maintaining a given dimensional stability at the same time. The second shaping step can also be subdivided into plural sub-shaping steps with a low degree of deformation, as is known from the above-cited prior art.

It has been found that, in this respect, the hydroxyl group content of the quartz glass and its axial distribution over the length of the intermediate cylinder are decisive parameters. The hydroxyl group content of quartz glass has impacts on the viscosity thereof. Thus, during the softening of the quartz glass, gradients in the hydroxyl group concentration cause local viscosity differences in the intermediate cylinder wall and these may lead to undesired and unforeseeable deformations.

This effect is even intensified in that the hydroxyl group content of the quartz glass also has impacts on the absorption of infrared radiation. A rather high hydroxyl group content leads to a more pronounced absorption and to increased emission in the infrared wavelength range. That type of quartz glass becomes hot at a faster pace and cools down at a faster pace than quartz glass with a rather low hydroxyl group content. Fluctuations in the hydroxyl group content therefore have an impact on the viscosity in several respects and lead to undesired and hardly controllable deformations in the shaping process.

In this respect, quartz glass of naturally occurring raw material that normally has a low hydroxyl group content should prove to be less sensitive to undesired deformations. This, however, is not confirmed in practice in such a clear and definite way. To the contrary, the shaping of quartz glass of natural raw material into true-to-scale large tubes turns out to be problematic. This can be ascribed to other impurities existing in the natural raw quartz material. Although synthetically produced quartz glass normally exhibits high purity, it often contains great amounts of hydroxyl groups due to the manufacturing process, and these impurities may lead to unforeseeable and undefined deformations in the case of high shaping degrees, as has been explained above.

The present invention now provides a method which, if narrow framework conditions are observed, permits an economic processing of synthetically produced quartz glass into true-to-scale large tubes although high shaping degrees are required for this.

The most important framework conditions are:
(a) Use of at least a two-stage shaping process where. in the first shaping stage. a forming tool is used for observing a predetermined outer diameter of the shaped product produced thereby as accurately as possible. The shaped product of this shaping stage serves as a start cylinder in the second shaping step which can directly follow the first one.
(b) It has turned out to be important that the synthetic quartz glass of the intermediate cylinder has a low mean hydroxyl group content of 10 wt. ppm or less, preferably 2 wt. ppm or less, and that the hydroxyl group content is distributed over the intermediate cylinder length homogeneously such that when the intermediate cylinder is subdivided into length segments having a length of 1 cm, neighboring length segments differ from one another by less than 2 wt. ppm, preferably less than 1 wt. ppm, in their mean hydroxyl group content.
(c) When conditions (a) and (b) are complied with, the second shaping stage for the large quartz-glass tube leads to a reproducible shaping behavior with a low demand for correction and subsequent control. Thus, even at a high shaping degree, it is possible in the best case to dispense with a forming tool. When a forming tool is used in this process, a minor action on the outer wall of the large tube is enough, so that a large quartz-glass tube with the desired dimensional stability, smooth and high-quality inner wall and, nevertheless, largely defect-free surface without streaks is obtained as the shaped product of this shaping step.

The preparation of synthetic quartz glass with such a low hydroxyl group content is normally carried out via a porous semifinished product of SiO₂ particles that permits a drying treatment for eliminating hydroxyl groups caused by the manufacturing process. The drying treatment of the porous SiO₂ body can here be carried out purely thermally, supported by negative pressure, or by chemical reaction with a drying reagent, such as chlorine. The adjustment of a mean hydroxyl group content of less than 10 wt. ppm here is less problematic than the generation of a concentration profile that is uniform over the volume of the porous SiO₂ body. DE 10 152 328 A1 describes a procedure for solving this problem that already starts in an early phase of the quartz-glass tube production.

If the synthetically produced quartz glass has a high mean hydroxyl group content above 10 wt. ppm, it turns out to be more and more difficult to ensure the desired dimensional stability of the large tube on the whole. If the axial concentration curve shows fluctuations of more than 2 wt. ppm/mm over a length of 1 cm, this will easily lead to local deviations of the wall thickness of the large tube in the second shaping process.

The content of hydroxyl groups of the quartz glass is found by measurement of the IR absorption according to the method of D. M. Dodd and D. B. Fraser, Optical determination of OH in fused silica, Journal of Applied Physics, Vol. 37(1966), p. 3911.

The mean content of hydroxyl groups of the quartz glass is here determined by way of a measurement through the tube wall in the direction of the longitudinal axis of the intermediate tube. The measurement value that is obtained in a measurement in the geometric center of the respective length segment through the wall of the intermediate tube and in a direction perpendicular to its longitudinal axis is considered as the mean value of the hydroxyl group content in length segments of 1 cm.

For the production of synthetically produced quartz glass, halogen-containing start substances, such as SiCl₄, or halogen-containing drying reagents, such as chlorine, or halogen-containing dopants, such as fluorine, are often used. That is why great amounts of halogens are contained in synthetic quartz glass. However, it has been found that in the second shaping step, apart from the hydroxyl group content, the halogen content, and here particularly the chlorine content, may have an influence on the dimensional stability of the final quartz-glass tube and on the bubble content.

Therefore, quartz glass is preferably used that has a mean chlorine concentration of less than 3000 wt. ppm.

The chlorine concentration is determined as a mean value of test samples that are taken at three points that are evenly distributed over the intermediate cylinder length (beginning, middle, end) in that the test samples are dissolved in aqueous HF solution and the solutions obtained thereby are subjected to a nephelometric analysis after addition of AgNO₃.

With respect to a dimensionally accurate adjustment of the outer diameter of the large tube, a procedure has turned out to be advantageous in which the large quartz-glass tube is not elongated in the second shaping step, the increase in diameter being due to centrifugal force or blow pressure.

Holders are here welded at the front side to the quartz glass cylinder to be shaped, and the holders are clamped in chucks of a glass lathe and rotated in synchronism. A heating source is moved zone by zone along the quartz glass cylinder. A defined internal pressure can be set in the inner bore of the quartz glass cylinder. Due to rotation and driven by the centrifugal force and the internal pressure, the inner bore will expand without the chucks having to be moved apart for that purpose.

It has turned out to be even particularly advantageous when the large quartz-glass tube is compressed in the second shaping step in the direction of its longitudinal length, such that its wall thickness after compression is between 70% and not more than 100% of its wall thickness prior to compression.

The goal of the second shaping step is here a diameter enlargement of the quartz glass tube while the wall thickness thereof is substantially maintained. This is possible by the initial length of the quartz glass tube being shortened in the shaping step; i.e., the initial tube is compressed. After compression, the wall thickness is preferably between 70% and not more than 100% of the initial value. A compression process which leads to an enlargement of the wall thickness (>100%) is also possible, but will result in undesired deformations.

Apart from the above-described demands made on the composition of the synthetically produced quartz glass, especially with respect to the admissible amount of hydroxyl groups and their local distribution, the homogeneity of the temperature field and the composition of the atmosphere in the area of the heating zone have turned out to be important parameters for a reproducible shaping process requiring hardly any control measures.

It has turned out to be useful particularly also for this reason when the heating zone is formed by a plurality of heating sources which are evenly distributed in the form of a ring around the circumference of the intermediate cylinder and are selected from the group of a plasma burner, a gas burner, and a laser.

With such heating sources, the heating energy can be adjusted in a locally more defined manner by comparison with a furnace and can be metered more rapidly and accurately, and a given temperature field can thereby be adjusted or corrected although it is not rotation-symmetrical. The heating sources are capable of providing high energy at selective points. At least five heating sources of such a type are distributed in the form of a circular ring around the intermediate cylinder to be softened. By comparison with a furnace, the diameter of the circular ring form can be adapted more easily to the diameter of the quartz glass cylinder to be softened, for instance when the second shaping step is subdivided into sub-shaping steps with a respectively smaller shaping degree, wherein the outer diameter of the quartz glass cylinder to be shaped becomes greater step by step. For the purpose of avoiding the input of hydroxyl groups, hydrogen-free plasma burners or a CO₂ laser are preferred.

Apart from hydroxyl groups and halogens, metallic oxide impurities also have an impact on the viscosity of the synthetic quartz glass; aluminum oxide should here particularly be mentioned. Possible concentration fluctuations of these impurities are the more pronounced and efficient, the higher their mean concentration is.

That is why quartz glass is preferably used that has a concentration of aluminum (Al) of less than 1 wt. ppm and a total content of other metallic impurities of less than 4 wt. ppm.

Moreover, it has turned out to be advantageous that the quartz glass has a concentration of alkali metal or alkaline-earth metal impurities of less than 0.3 wt. ppm.

Alkali and alkaline-earth ions have a noticeable impact on the viscosity of quartz glass already in a small amount and they promote the crystallization tendency thereof.

Although aluminum, as well as alkali and alkaline-earth impurities, are present in the quartz glass in an oxidic form, all of the above-mentioned weight specifications refer to the metallic form.

In a particularly preferred method variant, an initial hollow cylinder of quartz glass is supplied in the first shaping step to an electrically heated furnace, is softened therein zone by zone and is continuously pressed, while rotating about its longitudinal axis, with its cylinder outer jacket against the forming tool and is shaped by the forming tool continuously into the intermediate cylinder.

This procedure allows the production of rather thick-walled and nevertheless dimensionally more accurate intermediate cylinders.

An electrically heated furnace generally causes higher energy costs than heating by means of burners. On the other hand, the electrical heating process makes it easier to maintain a given temperature field and an atmosphere with a low water and hydrogen content. In this respect, an electrically heated furnace is preferably used for the shaping of the start cylinder into the intermediate cylinder. The dimensions of the furnace, viewed in the direction of the longitudinal axis of the cylinder, are at least 500 mm and the distance between the outer wall of the intermediate cylinder and an inner wall of the furnace is less than 100 mm. The intermediate cylinder obtained after the first shaping process can be processed subsequently.

A hollow cylinder 1 of synthetically produced quartz glass is provided that meets the high demands made on its purity and on the homogeneity of the viscosity-varying components.

The production comprises the flame hydrolysis of SiCl₄ in which SiO₂ particles are formed and deposited layer by layer on the cylinder surface of a carrier rotating about its longitudinal axis so as to form a soot body. To generate a specific radial density gradient within the soot body wall, the method known from DE 10 152 328 A is used; i.e., in the deposition of the first soot layers, a comparatively high surface temperature is generated and thus a soot portion with a comparatively high density of about 30%. Thereupon, the soot density is increasing further until it reaches about 32% in a “transition region.” When the subsequent soot layers are deposited, the surface temperature of the developing soot body is continuously lowered and the soot density is thus reduced. After completion of the deposition method and removal of the carrier rod, a soot tube is obtained with a specific radial density profile.

For cleaning and removing the hydroxyl groups introduced due to the manufacturing process, the soot tube is subjected to a dehydration treatment and is thereby treated in vertical orientation in a dehydration furnace first at a temperature of about 900° C. in a chlorine-containing atmosphere. The treatment duration is about eight hours. A lower hydroxyl-group content is thereby set.

The process-related varying efficiency of the chlorine penetrating via the outer surfaces into the soot body is compensated by the previously produced density profile, so that a largely homogeneous radial concentration profile for the hydroxyl groups is obtained over the thickness of the wall.

Thereafter, the soot tube is introduced into a vertically-oriented vitrification furnace and treated therein at a temperature of about 1000° C. for the purpose of removing chlorine and for saturating possible oxygen deficiency defects with oxygen. Subsequently, the soot tube is sintered at a temperature of around 1300° C. in that it is supplied to an annular heating zone and heated therein zone by zone.

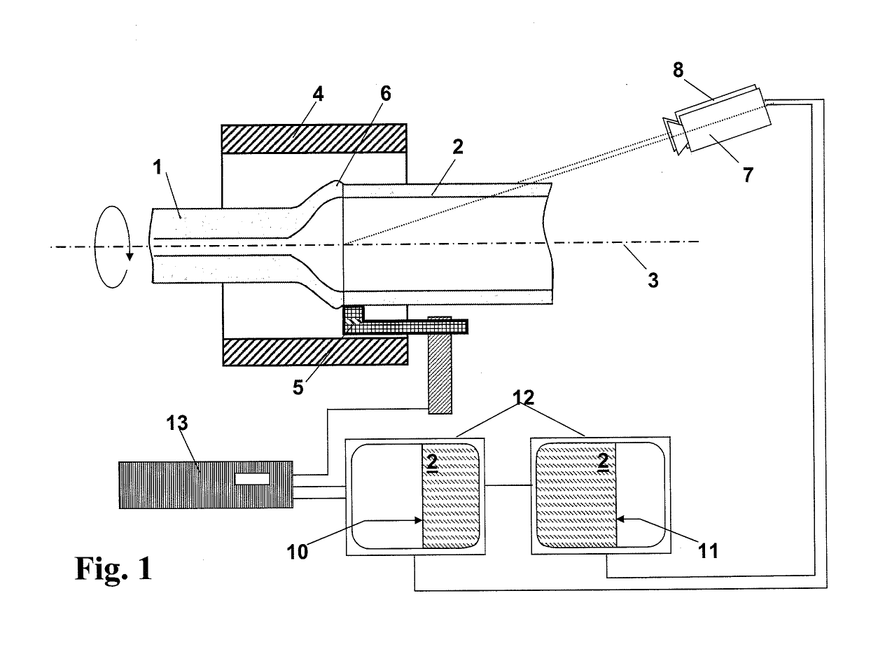

The hollow cylinder 1 produced in this way (see FIG. 1) has a length of 300 cm, an outer diameter of 200 mm, and an inner diameter of 40 mm. It consists of synthetic quartz glass, with a low content of metal oxide impurities, the concentrations of which (in wt. ppm) are indicated in Table 1.

TABLE 1

| Al | Ca | Cr | Cu | Fe | K | Li | Mg | Mn | Na | Ti | Zr |
|---|---|---|---|---|---|---|---|---|---|---|---|
| 0.4 | 0.2 | 0.01 | 0.01 | 0.3 | 0.1 | 0.02 | 0.1 | 0.005 | 0.1 | 0.3 | 0.4 |

All specifications in wt. ppm

The quartz glass has a mean hydroxyl group content of 8.3 wt. ppm (measured over the longitudinal axis of the tube), and a mean chlorine concentration of 1710 wt. ppm. Viewed over the length of the thick-walled hollow cylinder, the hydroxyl group content determined at 29 measuring points at a distance of 10 cm varies around +/−0.9 wt. ppm (standard deviation).

The first shaping step is carried out on the basis of the method described in DE 10 2007 051 898 A1.

FIG. 1 schematically shows the apparatus by means of which the thick-walled hollow cylinder 1 of quartz glass is shaped into a rather thin-walled intermediate cylinder 1 with an outer diameter of 320 mm, a wall thickness of 15 mm, and a length of 6.20 m.

The hollow cylinder 1 is moved by a feed device continuously while rotating about its longitudinal axis 3 at a feed rate of 4 cm/min into a resistance furnace 4 surrounding the hollow cylinder 1 in the form of a ring with an inner diameter of 400 mm, and is heated up therein zone by zone to a temperature of about 2100° C. For pulling purposes, use is made of a drawing device (not shown in FIG. 1) which draws off the intermediate cylinder 2 while rotating about its longitudinal axis 3 at a draw-off rate of about 12 cm/min in the direction of the longitudinal axis 3.

The hollow cylinder 1 of quartz glass is closed at its free front side with a gas-tight rotary feedthrough. A forming tool which comprises two water-cooled forming jaws 5 covered with graphite tongues (only shown schematically in FIG. 1) projects into the furnace 4. A gas stream is introduced into the rotating hollow cylinder 1 of quartz glass through the rotary feedthrough, so that a controllable internal overpressure of about 10 mbar is set. The hollow cylinder 1 is thereby blown up against the forming jaws 5 to the nominal diameter of 340 mm, with formation of a circumferential bead 6 in front of the forming jaws 6.

The intermediate cylinders 2 can thereafter detach from the forming jaws 5, so that the outer diameter that is really obtained can slightly deviate from the distance of the forming jaws. A schematically-illustrated measuring and controlling device 13 which comprises two high-resolution CCD cameras 7, 8 for detecting the longitudinal edges 10, 11 of the hollow cylinder 1 as well as monitors 12 displaying the relative axial position of the optically detected longitudinal edges 10, 11 is provided for measuring and controlling the outer diameter. For further details of the mode of operation of the control device 13, reference is made to DE 10 2007 051 898 A1.

The intermediate cylinder 2 obtained thereby is distinguished by a defined outer diameter and a high dimensional stability on the whole. The quality of the quartz glass invariably corresponds to that of the hollow cylinder 1, as has been explained above. It is suited as a defined starting product for producing a large tube.

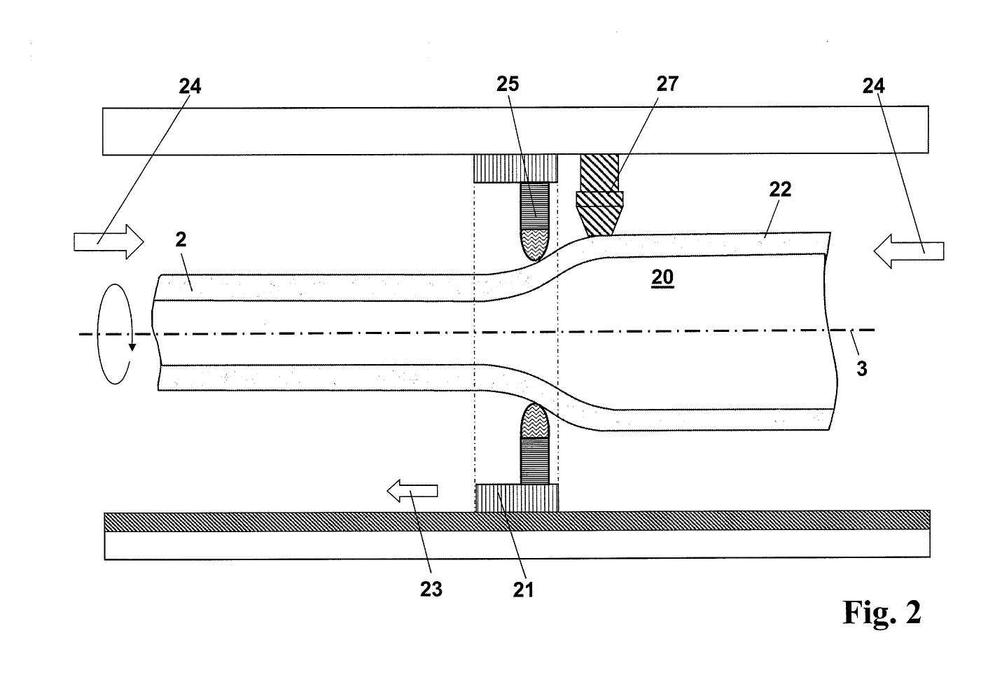

FIG. 2 schematically shows the apparatus for shaping the intermediate cylinder 2 into the desired large tube 22 with an outer diameter of 960 mm.

Holding tubes are welded to the intermediate cylinder 2 at the left and right sides (not shown in FIG. 2). These are clamped into the two chucks of a glass lathe and rotate in synchronism.

A burner carriage 21 moves along the intermediate cylinder 2 from the right to the left side, as indicated by the directional arrow 23. A burner ring which serves to heat and soften the intermediate cylinder 2 is mounted on the burner carriage 21. The burner ring 25 is formed of five gas burners distributed in the form of a circular ring and evenly around the longitudinal axis 3 of the cylinder.

Due to the advance movement of the burner carriage 21 at a rate of 4 cm/min, the intermediate cylinder 2 is heated while rotating about its longitudinal axis 3 at a speed of 60 rpm (corresponding to the rotation axis) continuously under the action of the burner ring and thus to a high temperature of about 2,100° C. The inner bore 20 can be flushed with a gas in this process, and a defined and controlled internal pressure of up to about 100 mbar can be set in the inner bore 20.

The quartz glass, by being heated in the burner ring 25, is given such a low viscosity that it can easily deform, so that the outer wall of the tube comes to rest under the action of centrifugal force and internal pressure against a forming part 27 of graphite with a wall thickness of 7.5 mm. An additional elongation does not take place here. To the contrary, the quartz glass tube is compressed, as outlined by the block arrows 24, in such a manner that the inflated large tube 22 has about the same wall thickness as the intermediate tube 2.

The quartz glass tube 22 obtained thereby serves as an intermediate cylinder 2 for a further shaping process with the help of the method shown in FIG. 2. The intermediate cylinder 2 is thereby expanded step by step into the large quartz-glass tube 22, wherein each deformation stage represents a diameter enlargement of 65 mm or less. The outer diameter of the burner ring 25 can be easily adapted to the respective outer diameter of the deformation stage.

The inflated large tube 22 has about the same wall thickness (100%) as the initially used intermediate tube 2 and is compressed to an end length of 2.976 m.

On the basis of this method, one obtains a large tube 22 of synthetic quartz glass with a high dimensional stability on the whole, namely in an economic way with only two shaping steps, while the above-explained boundary conditions with respect to the chemical composition of the quartz glass and its homogeneity are observed. The wall thickness variation of the large quartz-glass tube 22 produced in this way is less than 0.42 mm per tube length meter.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1-11. (canceled)

12. A method for producing a large quartz-glass tube (22) by multi-stage forming, the method comprising:
a first forming step in which, using a forming tool (5), an intermediate cylinder (2) of quartz glass is formed with an intermediate-cylinder wall thickness and an intermediate-cylinder outer diameter and is subsequently cooled; and
a second shaping step in which at least one length segment of the cooled intermediate cylinder (2) is supplied to a heating zone (25), heated therein zone by zone to a softening temperature and shaped while rotating about its longitudinal axis (3) into the large quartz-glass tube (22) with a final wall thickness and a final outer diameter,
wherein the quartz glass is synthetically produced and has a mean hydroxyl group content of 10 wt. ppm or less, and
wherein, when the intermediate cylinder is subdivided into length segments having a length of 1 cm, neighboring length segments show a difference of less than 2 wt. ppm in their mean hydroxyl group content.

13. The method according to claim 12, wherein the quartz glass has a mean hydroxyl group content of 2 wt. ppm or less, and wherein the neighboring length segments of the intermediate cylinder show a difference of less than 1 wt. ppm in their mean hydroxyl group content.

14. The method according to claim 12, wherein the quartz glass has a mean chlorine concentration of less than 3000 wt. ppm.

15. The method according to claim 12, wherein the large quartz-glass tube (22) is not elongated in the second shaping step, and wherein an increase in its diameter is due to centrifugal force or blowing pressure.

16. The method according to claim 12, wherein the large quartz-glass tube (22) is compressed in the second shaping step in the direction of its longitudinal axis (3), such that its wall thickness after compression is between 70% and not more than 100% of its wall thickness prior to compression.

17. The method according to claim 12, wherein the heating zone is formed by a plurality of heating sources (25) which are evenly distributed in the form of a ring around a circumference of the intermediate cylinder (2) and which are selected from the group consisting of a plasma burner, a gas burner and a laser.

18. The method according to claim 12, wherein the quartz glass has a concentration of aluminum (Al) of less than 1 wt. ppm and a total content of other metallic impurities of less than 4 wt. ppm.

19. The method according to claim 18, wherein the quartz glass has a concentration of alkali metal or alkaline-earth metal impurities of less than 0.3 wt. ppm.

20. The method according to claim 12, wherein in the first forming step, a start hollow cylinder (1) of quartz glass is supplied to an electrically heated furnace (4), softened therein zone by zone and continuously pressed while rotating about its longitudinal axis (3) with its cylinder outer jacket against the forming tool (5), and is shaped by the forming tool (5) continuously into the intermediate cylinder (2).

21. The method according to claim 21, wherein a dimension of the electrically heated furnace (4), viewed in the direction of the longitudinal axis (3) of the cylinder, is at least 500 mm and a distance between an outer wall of the intermediate cylinder (2) and an inner wall of the furnace (4) is less than 100 mm.

22. The method according to claim 12, wherein the large quartz-glass tube (22) has a wall thickness variation of less than 0.5 mm per tube length meter.
